(19) United States
(12) Patent Application Publication
(10) Pub. No.: US 2006/0220868 A1
(43) Pub. Date: Oct. 5, 2006

(54) Radio frequency identification tag package

(75) Inventors: Kazuyuki Takasawa, Tokyo (JP); Kiyoshi Imaizumi, Tokyo (JP)

Correspondence Address: BACON & THOMAS, PLLC, 625 SLATERS LANE, FOURTH FLOOR, ALEXANDRIA, VA, 22314, US

(73) Assignee: DAI NIPPON PRINTING CO., LTD., Tokyo (JP)

(21) Appl. No.: 11/444,502

(22) Filed: Jun. 1, 2006

Related U.S. Application Data
(63) Continuation of application No. PCT/JP05/13245, filed on Jul. 19, 2005.

(30) Foreign Application Priority Data
Feb. 16, 2005 (JP) 2005-039156
Jul. 20, 2004 (JP) 2004-211212

(51) Int. Cl. G08B 13/14

(52) U.S. Cl. 340/572.1; 340/572.8

(57) ABSTRACT

The present invention provides an RFID tag package which allows information stored in an RFID tag to be externally read or read/written, even if a metal-containing article or an article packed with a metal-containing packaging material is packaged. In an RFID tag package (100), an RFID tag (20) is attached to the outer surface of a casing (3) having a quadrilateral vertical cross section, and an inner bag (2) in which an article (1) is airtightly packed is placed in the casing (3). In the RFID tag package (100), a plate-shaped spacing member (5) having a specific thickness is inserted as spacing means between the inner bag (2) and a face plate (4) of the casing (3) to which the RFID tag (20) is attached.

### TECHNICAL FIELD

The present invention relates to a package including a radio frequency identification (RFID) tag (hereinafter called “RFID tag package”) in which an article is packaged.

### BACKGROUND ART

Along with development of semiconductor technology, RFID tags provided with various functions (performance) have been developed, and a reduction in size and manufacturing cost of the RFID tags has progressed. Therefore, use of the RFID tags has been examined in various industries such as apparel, food, and distribution industries in order to increase distribution efficiency by replacing barcodes.

Most commodities including food, cosmetics, medicine, toys, and miscellaneous goods are distributed and sold in the form of a packaged product. As the container used for such a packaged product, a bag, carton, plastic bottle, glass bottle, metal can, and the like can be given. A container formed by combining two or more containers, such as a bag and a carton, a plastic bottle and a carton, a glass bottle and a carton, or a metal can and a carton, is also used.

As the carton, a carton formed by a material containing paper as the major component, such as paper board, a laminate material obtained by attaching two or more sheets of paper and/or paper board, a laminate material obtained by further attaching a plastic film, or corrugated cardboard, is generally used.

The RFID tags are roughly divided into (1) a read-only RFID tag, (2) a readable/writable RFID tag, (3) an RFID tag including a microprocessor, and (4) an RFID tag including a sensor. In order to improve the distribution efficiency by attaching the RFID tag to a packaged product, the read-only RFID tag (1) and the readable/writable RFID tag (2) can be easily used due to inexpensiveness. The RFID tag (3) including a microprocessor and the RFID tag (4) including a sensor are also used depending on the desired function.

Patent document 1 discloses a packaged product provided with an RFID tag having a noncontact communication function, the packaged product being a laminate formed by printing an antenna having an arbitrary pattern on at least a part of a base film or sheet using conductive ink, attaching an IC tag label to the antenna printed surface, and stacking a sealant film over the IC tag label. In this packaged product, the RFID tag is prevented from being removed during distribution.

However, in the case where an article packed in a packaged product is a bag formed by a stacked film containing a metal layer, such as aluminum foil, or a metal can, the metal is positioned on the back surface of the RFID tag when the RFID tag is attached to the surface of the packaged product. As a result, a magnetic field does not reach the antenna when utilizing an electromagnetic induction communication method (13.56 MHz band), or communication may not be achieved when utilizing a 2.45 GHz band or a UHF band due to mistuning of the antenna.

Patent document 1: JP-A-2003-158414

### DISCLOSURE OF THE INVENTION

### PROBLEMS TO BE SOLVED BY THE INVENTION

An objective of the present invention is to provide an RFID tag package which allows information stored in the RFID tag to be externally read or read/written, even if a metal-containing article or an article packed with a metal-containing packaging material is packaged.

### MEANS FOR SOLVING THE PROBLEMS

A first invention provides a radio frequency identification (RFID) tag package in which a metal-containing article or an article packed with a metal-containing packaging material is packaged, the RFID tag package comprising: a casing in which the article is packaged; an RFID tag attached to an arbitrary surface of the casing; and spacing means for maintaining the article and the RFID tag at a distance equal to or greater than a specific distance, the spacing means being provided inside the casing at least in the area in which the RFID tag is attached.

A second invention provides the RFID tag package according to the first invention, wherein the article is airtightly packed with a packaging material formed by a stacked film including metal foil or a metal deposited layer.

A third invention provides the RFID tag package according to the first invention, wherein the spacing means is a sheet having a specific thickness, the sheet being inserted between the article and the area of the casing in which the RFID tag is attached and having an air layer and/or a bubble layer.

A fourth invention provides the RFID tag package according to the first invention, wherein the spacing means is a sheet having a specific thickness, the sheet being bonded to an inner surface of the casing in the area in which the RFID tag is attached and having an air layer and/or a bubble layer.

A fifth invention provides the RFID tag package according to the first invention, wherein the spacing means is a partition plate which divides an inner space of the casing into a first portion including an area in which the RFID tag is attached and a second portion in which the RFID tag is not attached, and the article is packaged in the second portion.

A sixth invention provides the RFID tag package according to the first invention, wherein a recess portion is formed in an outer surface of the casing, and the RFID tag is provided in the recess portion.

A seventh invention provides the RFID tag package according to the first invention, wherein the casing is formed by a laminate material obtained by attaching a plurality of sheets including at least one paper sheet, and the RFID tag is provided between the sheets of the laminate material.

An eighth invention provides the RFID tag package according to the seventh invention, wherein the laminate material includes at least one paper sheet, a recess portion is formed in the paper sheet, and the RFID tag is provided in the recess portion.

A ninth invention provides the RFID tag package according to the seventh invention, wherein a camouflaging print layer, which prevents surface deformation due to the RFID tag from being observed, is provided on the outer surface of the casing in the area in which the RFID tag is attached.

A tenth invention provides the RFID tag package according to the first invention, wherein the casing is formed by a stacked film which does not include paper.

An eleventh invention provides the RFID tag package according to the first invention, wherein the casing is formed by a laminate material prepared by attaching two or more sheets, and the RFID tag is provided between the sheets of the laminate material.

A twelfth invention provides the RFID tag package according to the first invention, wherein the spacing means includes bonding the inner side of the casing and the article in an area at a distance equal to or greater than a specific distance from the RFID tag.

### EFFECT OF THE INVENTION

According to the present invention, even if a metal-containing article or an article packed with a metal-containing packaging material is packaged in the casing, since the article is separated from the back surface of the RFID tag at a distance equal to or greater than a specific distance by the spacing means provided inside the casing at least in the area in which the RFID tag is attached, information concerning the article in the package which is written into the RFID tag can be reliably read or rewritten with different information from the outside. Therefore, the efficiency of commodity distribution can be further improved.

### BRIEF DESCRIPTION OF THE DRAWINGS

FIG. 1 is a cross-sectional view schematically showing a first embodiment of an RFID tag package according to the present invention.

FIG. 2 is a plan view schematically showing an example of an RFID tag used for the RFID tag package according to the first embodiment.

FIG. 3 is a cross-sectional view schematically showing a second embodiment of the RFID tag package according to the present invention.

FIG. 4 is a cross-sectional view schematically showing a third embodiment of the RFID tag package according to the present invention.

FIG. 5 is a cross-sectional view schematically showing a fourth embodiment of the RFID tag package according to the present invention.

FIG. 6 is a cross-sectional view schematically showing an RFID tag carton as a fifth embodiment of the RFID tag package according to the present invention.

FIG. 7 is a cross-sectional view schematically showing an example of a carton laminate material used for the RFID tag package according to the fifth embodiment.

FIG. 8 is a cross-sectional view schematically showing an RFID tag carton as a sixth embodiment of the RFID tag package according to the present invention.

FIG. 9 is a cross-sectional view schematically showing an RFID tag carton as a seventh embodiment of the RFID tag package according to the present invention.

### EXPLANATION OF SYMBOLS

1: Article, 2: inner bag, 3: casing, 4: face plate, 5: spacing member, 6: partition plate, 7a, 7b: adhesive portion, 8: recess portion, 9: another article, 10: carton laminate material, 11: outer paper layer, 12: inner paper layer, 13: print layer, 14: adhesive layer, 20, 20a: RFID tag, 21: support, 22: antenna, 23: IC chip, 50: metal-containing article, 100, 200, 300, 400: RFID tag package, 500, 600, 700: RFID tag carton

### BEST MODE FOR CARRYING OUT THE INVENTION

The present invention achieves the objective of providing an RFID tag package which allows information stored in the RFID tag to be externally read or read/written, even if a metal-containing article or an article packed with a metal-containing packaging material is packaged, by disposing a spacing member or the like for maintaining the article and the RFID tag at a distance equal to or greater than a specific distance inside a casing at least in the area in which the RFID tag is attached.

Embodiments of the present invention are described below with reference to the drawings. Note that the drawings should not be construed as limiting the scope of the present invention.

### First Embodiment

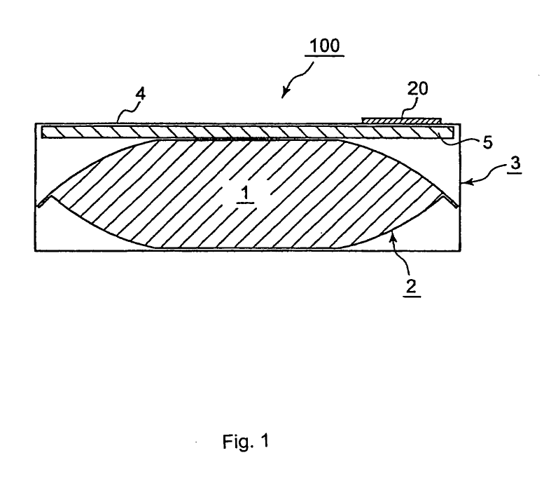

FIG. 1 is a cross-sectional view schematically showing a first embodiment of an RFID tag package according to the present invention.

An RFID tag package 100 according to the first embodiment includes a casing 3 having a quadrilateral vertical cross section, an RFID tag 20 attached to a part of the outer surface of the casing 3, and an inner bag 2 packaged in the casing 3 with an article 1 being airtightly packed therein. In the RFID tag package 100, a plate-shaped spacing member 5 (spacing means) having a specific thickness is inserted between the inner bag 2 and a face plate 4 of the casing 3 to which the RFID tag 20 is attached.

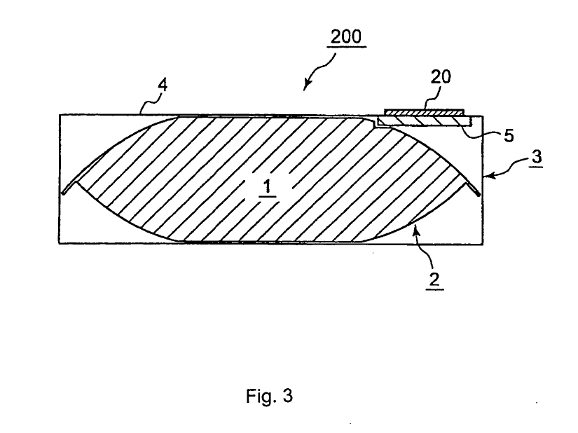

The inner bag 2 is formed by a stacked film including metal foil or a metal deposited layer containing aluminum, copper, or the like. This also applies to RFID tag packages shown in FIGS. 3 to 5 described later.

As the spacing member 5, corrugated cardboard having a specific thickness and having an air layer formed by wave-shaped flutes in its thickness direction, a foamed plastic sheet having a bubble layer, or the like may be used. The spacing member 5 may be a three-dimensional product formed by folding paper or a sheet, or may be a three-dimensional product formed by injection-forming plastic. In FIG. 1, the spacing member 5 is smaller than the face plate 4 to some extent in order to facilitate insertion of the spacing member 5. However, the RFID tag 20 and the inner bag 2 can be reliably separated at a distance corresponding to at least the thickness of the spacing member 5, even if the spacing member 5 moves in the horizontal direction. Therefore, information stored in the RFID tag 20 can be reliably read or rewritten with different information from the outside.

Since the spacing member 5 can be inserted into the casing 3 when inserting the inner bag 2, the spacing member 5 can be inserted with high productivity due to the simple operation. The spacing member 5 can be easily formed by an inexpensive material such as corrugated cardboard or foamed plastic. Therefore, the RFID tag package can be provided at low cost with high productivity.

The thickness of the spacing member 5 may be 3 to 5 mm or more and about 10 mm or less. As the corrugated cardboard, single-faced corrugated cardboard, double-faced corrugated cardboard, double-wall corrugated cardboard, or a sheet formed by stacking two or more sheets of such corrugated cardboard may be used. As the foamed plastic sheet, a foamed polystyrene sheet, a foamed polypropylene sheet, or the like is preferable. The plastic may be recycled plastic in order to reduce the cost.

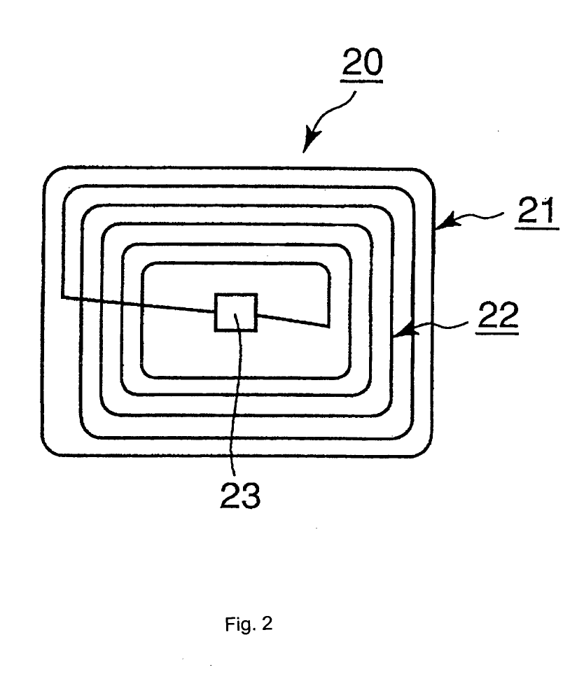

FIG. 2 is a plan view schematically showing an example of the RFID tag used for the RFID tag package according to the first embodiment.

The RFID tag 20 includes a support 21 such as a polyethylene terephthalate sheet, a conductive antenna 22 for receiving and transmitting information using electromagnetic waves, the antenna 22 being provided on the support 21 and made of copper or the like, and an IC chip 23 which is a storage device connected with the antenna 22 and used for information processing. In the RFID tag 20, a protective layer (not shown) such as a protective film may be arbitrarily provided on the support 21 to cover the antenna 22 and the IC chip 23.

A method of attaching the RFID tag 20 to an arbitrary surface of the casing 3 is not particularly limited. A method using a hot-melt adhesive or a pressure-sensitive adhesive is convenient due to high bonding speed and easy operation. In particular, when using a pressure-sensitive adhesive, automatic bonding using a labeling machine is facilitated by providing a separation treatment in advance using a release paper, whereby the RFID tag 20 can be attached with high productivity.

### Second Embodiment

FIG. 3 is a cross-sectional view schematically showing a second embodiment of the RFID tag package according to the present invention.

In each embodiment described below, sections functioning in the same manner as in the first embodiment are indicated by the same symbols. These sections are appropriately omitted in the description and the drawings.

An RFID tag package 200 according to the second embodiment differs from the RFID tag package 100 according to the first embodiment shown in FIG. 1 in that the size of the spacing member 5 inserted between the inner bag 2 and the face plate 4 of the casing 3 to which the RFID tag 20 is attached is reduced to such an extent that the inner surface of the face plate 4 can be covered at least in the area in which the RFID tag 20 is attached, and that the spacing member 5 is attached to the inner surface of the face plate 4 using an adhesive in the area in which the RFID tag 20 is attached to the outer surface.

The spacing member 5 may be attached at a specific position of the casing 3 when forming the casing 3 or when inserting the inner bag 2 into the casing 3 depending on the type of the casing 3.

In the RFID tag package 200 according to the second embodiment, since the RFID tag 20 attached to a part of the outer surface of the casing 3 and the inner bag 2 can be reliably separated at a distance corresponding to at least the thickness of the spacing member 5, the RFID tag 20 is not adversely affected by the metal foil or the metal deposited layer containing aluminum, copper, or the like included in the stacked film of the inner bag 2, whereby information stored in the RFID tag 20 can be reliably read or rewritten with different information from the outside.

### Third Embodiment

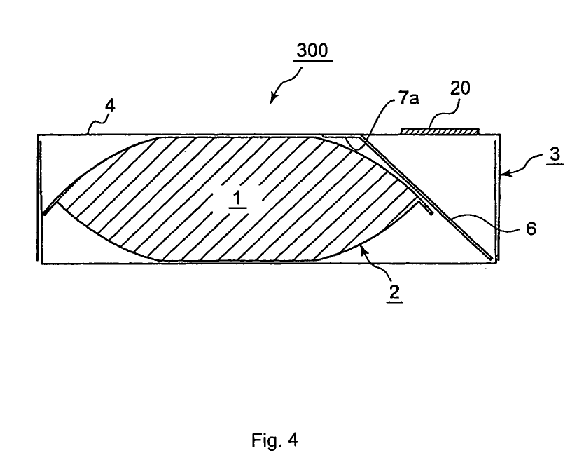

FIG. 4 is a cross-sectional view schematically showing a third embodiment of the RFID tag package according to the present invention.

In an RFID tag package 300 according to the third embodiment, the RFID tag 20 is attached to a part of the outer surface of the casing 3. A partition plate 6 (spacing means) is obliquely provided in the casing 3 to divide the casing 3 into a first portion in which the RFID tag 20 is attached to the outer surface and a second portion in which the RFID tag 20 is not attached. In the RFID tag package 300, the inner bag 2 is placed in the second portion in which the RFID tag 20 is not attached.

The partition plate 6 includes an adhesive portion 7a only on one end. The adhesive portion 7a is bonded to the inner surface of the upper face plate 4 to which the RFID tag 20 is attached on the outer surface. The other end of the partition plate 6 is not bonded to the inner surface of the casing 3. The partition plate 6 is formed to have such a length that the end of the partition plate 6 which is not bonded abuts against and is placed fittingly to the lower corner of the casing 3 when forming the casing 3, whereby the partition plate 6 is obliquely disposed.

In the RFID tag package 300 according to the third embodiment, since the partition plate 6 limits the movement of the inner bag 2 packaged in the casing 3 within the area in which the RFID tag 20 is not attached to the outer surface of the casing 3, the RFID tag 20 and the inner bag 2 can be separated at a sufficient distance. In the RFID tag package 300, the distance between the RFID tag 20 and the inner bag 2 can be easily increased to 10 mm or more, for example.

Therefore, the RFID tag package 300 according to the third embodiment allows information stored in the RFID tag 20 to be more reliably read or rewritten with different information from the outside without being adversely affected by the metal foil or the metal deposited layer containing aluminum, copper, or the like included in the stacked film of the inner bag 2.

### Fourth Embodiment

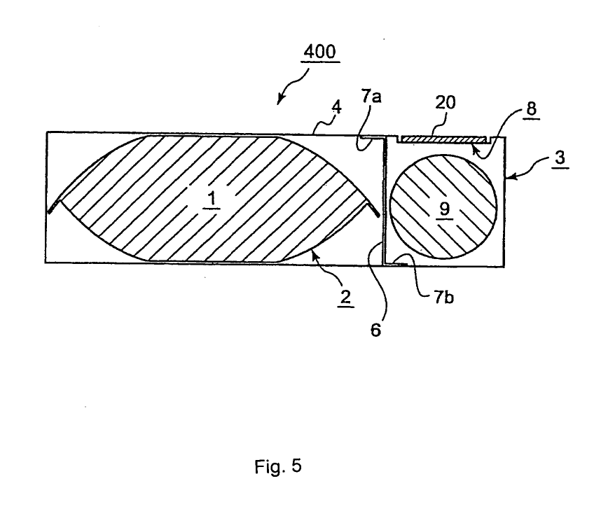

FIG. 5 is a cross-sectional view schematically showing a fourth embodiment of the RFID tag package according to the present invention.

In an RFID tag package 400 according to the fourth embodiment, a recess portion 8 having a depth approximately corresponding to the thickness of the RFID tag 20 is provided in the upper face plate 4 of the casing 3 at a position at which the RFID tag 20 is attached, and the RFID tag is provided in the recess portion 8.

The recess portion 8 is provided to prevent the RFID tag 20 from protruding from the outer surface of the casing 3 when providing the RFID tag 20 in the recess portion 8. It suffices that the recess portion 8 have a depth approximately equal to the thickness of the RFID tag 20. The thickness of the RFID tag 20 is generally about 1 mm or less, and the recess portion 8 may be formed to have a depth of about 1 mm or less. In the RFID tag package 400, since the RFID tag 20 can be attached to the outer surface of the casing 3 so that the RFID tag 20 does not protrude from the outer surface, the RFID tag 20 can be prevented from being damaged or removed during transportation or handling, whereby the RFID tag package 400 can be used more reliably.

The partition plate 6 (spacing means) is vertically disposed in the casing 3 to divide the inner space of the casing 3. The partition plate 6 includes adhesive portions 7a and 7b on either end. The adhesive portions 7a and 7b are respectively bonded to the upper and lower face plates of the casing 3. The partition plate 6 divides the inner space of the casing 3 into the area in which the RFID tag 20 is attached to the outer surface and the area in which the RFID tag 20 is not attached. The RFID tag package 400 is configured so that the inner bag 2 is placed in the area in which the RFID tag 20 is not attached.

In the RFID tag package 400 according to the fourth embodiment, since the RFID tag 20 attached to the outer surface of the casing 3 is provided in the recess portion 8, the RFID tag 20 does not protrude from the outer surface of the casing 3. Therefore, the RFID tag 20 is prevented from being damaged or removed due to friction on the outside, whereby the RFID tag package 400 can be used more reliably.

In the RFID tag package 400, the partition plate 6 disposed in the vertical direction limits the movement of the inner bag 2 placed inside the casing 3 within the area in which the RFID tag 20 is not attached to the outer surface, and the area in which the RFID tag 20 is attached to the outer surface can be increased in comparison with the RFID tag package 300 according to the third embodiment. Therefore, the distance between the RFID tag 20 and the inner bag 2 can be further increased.

Therefore, the RFID tag package 400 can be more reliably prevented from being adversely affected by the metal foil or the metal deposited layer containing aluminum, copper, or the like included in the stacked film of the inner bag 2, whereby information stored in the RFID tag 20 can be more reliably read or rewritten with different information from the outside.

In the RFID tag package 400, since the area in which the RFID tag 20 is attached to the outer surface is comparatively large, when packing an article which does not contain a metal in the casing 3 in addition to the inner bag 2, another article 9 can be packed in the area in which the RFID tag 20 is attached to the outer surface.

In the RFID tag packages 300 and 400 according to the third and fourth embodiments, the partition plate 6 may be provided in the casing 3 over the total length of the casing 3 in the depth direction (direction perpendicular to the sheet of the drawing), or may be provided corresponding to the length of the area in which the RFID tag 20 is attached.

The present invention is described below in more detail by way of production examples.

### PRODUCTION EXAMPLE 1

In Production Example 1, the RFID tag package 100 according to the first embodiment was produced using materials and sizes given below.

(1) The casing 3 was formed by forming paper board (coated cardboard, basis weight: 310 g/m²) into a sealed carton having a length of 170 mm, a width of 130 mm, and a thickness of 25 mm.

(2) The inner bag 2 was formed by forming a laminated film having a configuration given below into a bag sealed on the four sides. The inner bag 2 was filled with 220 g of retort curry (article 1) and then closed.

(Configuration of Inner Bag Stacked Film)

Biaxially stretched polyethylene terephthalate film (thickness: 12 μm)/adhesive/biaxially stretched nylon film (thickness: 15 μm)/adhesive/aluminum foil (thickness: 7 μm)/adhesive/unstretched polypropylene film (thickness 60 μm) (sealant layer)

The films were stacked and bonded by a dry lamination method. As the adhesive provided between the films, a dry lamination two-component curable polyurethane adhesive was used.

(3) As the spacing member 5, a product obtained by die cutting double-faced corrugated board having a thickness of 4 mm at a length of 160 mm and a width of 120 mm was used. (4) As the RFID tag 20, an electromagnetic induction type RFID tag in the shape of a sheet having a length of 45 mm, a width of 50 mm, and a thickness of 0.7 mm was used.

The inner bag 2 and the spacing member 5 were placed in the casing 3 so that the inner bag 2 and the spacing member 5 were arranged as shown in FIG. 1, and the casing 3 was then closed. The RFID tag 20 was bonded to the upper face plate 4 of the casing 3 using a hot-melt adhesive at a position near the corner to obtain an RFID tag package of Production Example 1.

### PRODUCTION EXAMPLE 2

An RFID tag package of Production Example 2 corresponds to the RFID tag package 200 according to the second embodiment. As the casing 3, the inner bag 2, and the RFID tag 20, those used in Production Example 1 were used. The spacing member 5 was formed by die cutting double-faced corrugated board having a thickness of 4 mm at a length of 60 mm and a width of 65 mm. The spacing member 5 was bonded in advance to the inner surface of the casing 3 using an adhesive (ethylene-vinyl acetate copolymer emulsion) at a position at which the RFID tag 20 was attached to the outer surface. The remaining production conditions for the RFID tag package of Production Example 2 were the same as in Production Example 1.

### PRODUCTION EXAMPLE 3

An RFID tag package of Production Example 3 corresponds to the RFID tag package 400 according to the fourth embodiment. As the casing 3, the inner bag 2, and the RFID tag 20, those used in Production Example 1 were used. The recess portion 8 having a depth of 0.9 mm was formed in the outer surface of the casing 3 (carton blank) by a thermal embossing method in the area in which the RFID tag 20 was attached, and the RFID tag 20 was provided in the recess portion 8 using a hot-melt adhesive. The partition plate 6 dividing the inner space of the casing 3 was provided by providing the coated cardboard (basis weight: 310 g/m²) used for the casing 3 over the entire thickness of the casing 3 when forming (packing) the casing 3 (sealed carton). The remaining production conditions for the RFID tag package of Production Example 3 were the same as in Production Example 1.

### COMPARATIVE EXAMPLE 1

An RFID tag package of Comparative Example 1 was produced in the same manner as the RFID tag package of Production Example 1 except that the spacing member 5 was not inserted into the casing 3 and the thickness of the casing 3 was reduced from 25 mm to 21 mm corresponding to the thickness (4 mm) of the spacing member 5.

In order to evaluate the RFID tag packages of Production Examples 1 to 3 and Comparative Example 1 thus obtained, a test was conducted in which each RFID tag package was used as a sample and information stored in the RFID tag 20 was read using a reader/writer (electromagnetic induction type) at a distance of 30 cm.

As a result, the information could be read from the samples of Production Examples 1, 2, and 3, since the RFID tag 20 and the aluminum foil provided in the stacked film of the inner bag 2 were separated by the spacing member 5 or the partition plate 6 at a distance of at least 4 mm.

In the sample of Comparative Example 1, since the spacing member 5 was not inserted between the casing 3 and the inner bag 2, the distance between the RFID tag 20 attached to the outer surface of the casing 3 and the aluminum foil provided in the stacked film of the inner bag 2 was reduced to about 1 mm, whereby the information stored in the RFID tag 20 could not be correctly read due to an adverse effect of the aluminum foil.

### Fifth Embodiment

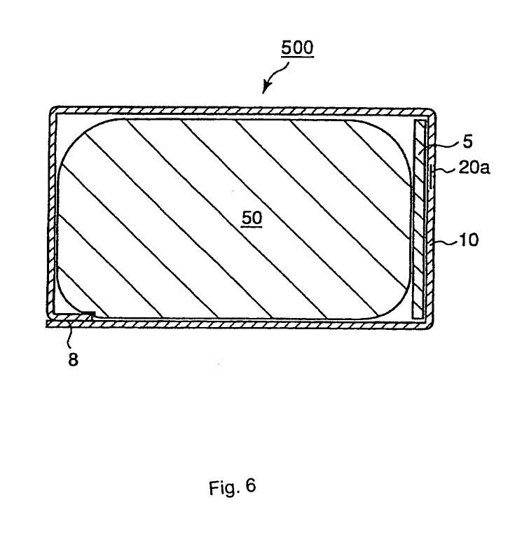

FIG. 6 is a cross-sectional view schematically showing an RFID tag carton as a fifth embodiment of the RFID tag package according to the present invention.

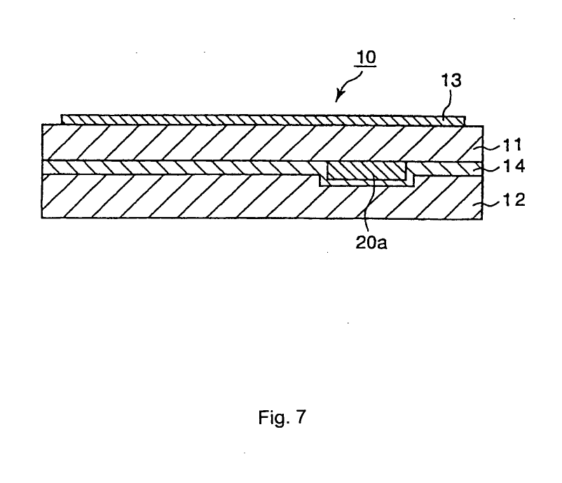

FIG. 7 is a cross-sectional view schematically showing an example of a carton laminate material used for the RFID tag package according to the fifth embodiment.

An RFID tag carton 500 according to the fifth embodiment is formed by die cutting and forming a carton laminate material 10 shown in FIG. 7 in the same shape as that of a horizontal sealed carton in which the vertical cross section of the body portion is quadrilateral.

In the RFID tag carton 500, the body portion is bonded at an adhesive section 8 at the lower left corner in FIG. 6 and formed in the shape of a prism. An RFID tag 20a is provided between paper layers of the laminate material 10 at a position upward to some extent from the middle portion of the laminate material 10 forming the right wall. In the RFID tag carton 500, the plate-shaped spacing member 5 (spacing means) having a specific thickness is inserted between the inner side of the wall in which the RFID tag 20a is provided and an article 50 containing a metal therein when placing the article 50 inside the RFID tag carton 500.

The metal-containing article 50 placed inside the carton 500 includes a metal-containing article such as an electronic member and an article airtightly packed with a packaging material including a metal layer such as aluminum foil or an aluminum deposited layer.

As the spacing member 5, a corrugated cardboard sheet or a foamed plastic sheet having a thickness of 3 to 5 mm or more and about 10 mm or less may be suitably used, as described above.

As shown in FIG. 7, the carton laminate material 10 is formed by providing a print layer 13 containing characters, a pattern, or the like on the surface (upper surface in FIG. 7) of an outer paper layer 11, attaching the RFID tag 20a to the back surface (lower surface in FIG. 7) of the paper layer 11 at a specific position with respect to the print layer 13 containing characters, a pattern, or the like when forming the laminate material 10 into a carton, and attaching an inner paper layer 12 to the lower surface of the paper layer 11 through an adhesive layer 14.

The print layer 13 may be provided with a camouflaging print on the outer surface in the area in which the RFID tag 20a is provided so that deformation of the surface of the print layer 13 due to the presence of the RFID tag 20a is not easily recognized.

In the laminate material 10, a recess portion may be formed in at least one of the paper layers by embossing or hot pressing means when providing the RFID tag 20a between the paper layers, and the RFID tag 20a may be provided in the recess portion. The recess portion is provided in order to reliably provide the RFID tag 20a between the paper layers. The thickness of the recess portion is not particularly limited. The recess portion is suitably provided to have a thickness of about half or more and equal to or less than the thickness of the RFID tag 20a. Specifically, since the thickness of the RFID tag is about 0.06 to 1 mm, the recess portion is preferably provided to have a depth of about 0.03 to 1 mm.

The recess portion prevents mispositioning or the like when providing the RFID tag 20a between the paper layers, whereby the RFID tag 20a can be more reliably provided at a specific position of the carton 500. When forming the recess portion in the outer paper layer of the carton 500, swelling in the shape of the recess portion occurs on the outer surface of the carton 500 so that the position of the RFID tag 20a can be observed with the naked eye from the outside, whereby the presence of the RFID tag 20a can be confirmed.

As the RFID tag 20a, the RFID tag 20 as shown in FIG. 2 may be used, for example. The method for providing the RFID tag 20a on the back surface of the outer paper layer 11 is not particularly limited. For example, the RFID tag 20a may be bonded to the back surface of the outer paper layer 11 using a pressure-sensitive adhesive, a hot-melt adhesive, a heat sealing agent (heat-sensitive adhesive), or the like.

As the outer paper layer 11 and the inner paper layer 12, paper board or paper may be used. Or, a paper layer obtained by attaching two or more sheets of paper and/or paper board may also be used. When using a paper layer obtained by attaching two or more sheets of paper and/or paper board, a film-shaped material which does not contain a metal, such as a plastic film or synthetic paper, may be additionally attached.

The outer paper layer 11 and the inner paper layer 12 may attached by a wet lamination method using a vinyl acetate emulsion adhesive or the like as the material for the adhesive layer 14, or may be attached by an extrusion lamination method using an adhesive resin such as polyethylene as the material for the adhesive layer 14. When attaching the outer paper layer 11 and the inner paper layer 12 by the extrusion lamination method, the effect of embedding the RFID tag 20a can be obtained since the thickness of the adhesive layer 14 can be increased.

The carton laminate material 10 may be formed into an RFID tag carton having a desired shape by die cutting and forming the carton laminate material 10 in the same manner as in known carton manufacture using the print layer 13 containing characters, a pattern, or the like provided on the surface of the carton laminate material 10 as a reference.

In the RFID tag package 500 according to the fifth embodiment, since the RFID tag 20a and the metal-containing article 50 can be reliably separated at a distance of 3 to 5 mm or more and about 10 mm or less, information stored in the RFID tag 20a can be reliably read or rewritten with different information from the outside, whereby the efficiency of commodity distribution can be further increased.

Moreover, since the RFID tag 20a is provided between the paper layers of the carton 500, the RFID tag 20a cannot be seen from the outside. This prevents the design of the carton 500 from being impaired, whereby the print design is not affected.

In addition, since a person other than the manufacturer or the like cannot know that the RFID tag 20a is provided in the carton 500, a mischief prevention effect can be obtained.

### Sixth Embodiment

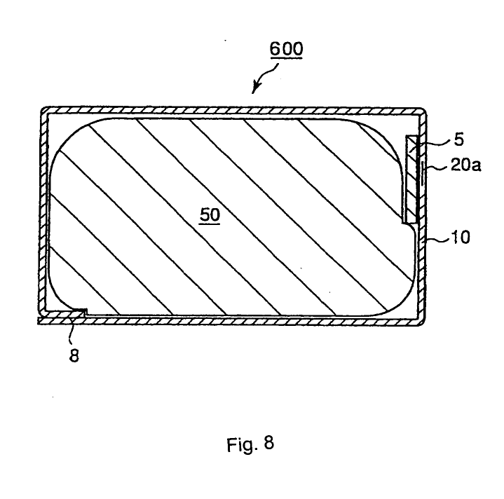

FIG. 8 is a cross-sectional view schematically showing an RFID tag carton as a sixth embodiment of the RFID tag package according to the present invention.

An RFID tag carton 600 according to the sixth embodiment differs from the RFID tag carton 500 according to the fifth embodiment in that the size of the spacing member 5 inserted between the wall of the carton 600 in which the RFID tag 20a is provided and the article 50 is reduced to such an extent that at least the inner surface of the wall can be covered in the area in which the RFID tag 20a is provided, and that the spacing member 5 is bonded to the inner surface of the wall using an adhesive in the area in which the RFID tag 20a is provided. The remaining features of the RFID tag carton 600 are the same as those of the RFID tag carton 500.

The spacing member 5 may be attached in advance at a specific position of the carton 600 when forming the carton 600, or may be attached at a specific position of the carton 600 when inserting the article 50 into the carton 600, depending on the type of the carton 600.

In the RFID tag carton 600 according to the sixth embodiment, since the RFID tag 20a provided between the paper layers of the wall of the carton 600 and the article 50 can be reliably separated at a distance corresponding to at least the thickness of the spacing member 5, the RFID tag 20a is not adversely affected by the metal contained in the article 50 when externally reading/writing information from/into the RFID tag 20a using a reader/writer, whereby information stored in the RFID tag 20a can be reliably read or rewritten with different information from the outside.

### Seventh Embodiment

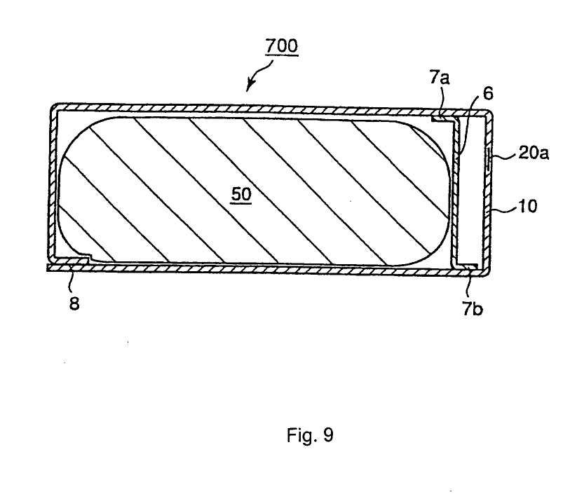

FIG. 9 is a cross-sectional view schematically showing an RFID tag carton as a seventh embodiment of the RFID tag package according to the present invention.

In the RFID tag carton 500 according to the fifth embodiment, the spacing member 5 having a specific thickness is inserted between the wall in which the RFID tag 20a is provided and the article 50 as the spacing means for maintaining the RFID tag 20a and the metal-containing article 50 at a distance equal to or greater than a specific distance. In an RFID tag package 700 according to the seventh embodiment, the adhesive portions 7a and 7b of the partition plate 6 (spacing means) are bonded to the inner surfaces of the carton 700 as shown in FIG. 9 to divide the inner space of the carton 700 into the area in which the RFID tag 20a is positioned and the area in which the RFID tag 20a is not positioned, and the article 50 is placed in the area in which the RFID tag 20a is not positioned.

In the RFID tag carton 700 according to the seventh embodiment, the movement of the article 50 placed in the carton 700 is limited by the partition plate 6 within the area in which the RFID tag 20a is not positioned, and the area in which the RFID tag 20a is positioned can be easily increased. Therefore, the distance between the RFID tag 20a and the article 50 can be easily increased to 10 mm or more.

Therefore, the RFID tag carton 700 according to the seventh embodiment more reliably prevents an adverse effect of the metal contained in the article 50, whereby information stored in the RFID tag 20 can be more reliably read or rewritten with different information from the outside.

The present invention is described below in more detail by way of production examples.

### PRODUCTION EXAMPLE 4

In Production Example 4, the RFID tag carton 500 according to the fifth embodiment was produced using materials and sizes given below.

(1) As the carton 500, a horizontal sealed carton having a length of 120 mm, a width of 200 mm, and a thickness of 80 mm was formed.

(2) The carton laminate material 10 was formed as follows. Coated cardboard (basis weight: 310 g/m²) was used as the outer paper layer 11. A print layer containing characters, a pattern, or the like was printed on the surface of the outer paper layer 11 using a multi color photogravure press. As the RFID tag 20a, an electromagnetic induction type RFID tag having a length of 45 mm, a width of 45 mm, and a thickness of 0.6 mm was bonded at a specific position of the back surface of the print layer by a heat sealing method using a heat sealing agent. As the inner paper layer 12, coated cardboard (basis weight: 230 g/m²) was bonded to the back surface of the outer paper layer 11 by an extrusion lamination method using low-density polyethylene (thickness: 30 μm) as the adhesive layer 14 between the inner paper layer 12 and the outer paper layer 11.

(3) The carton laminate material 10 was die cut in the shape of a carton blank and packed at the adhesive section 8 to obtain the sealed carton 500.

(4) As the spacing member 5, a sheet obtained by die cutting a double-faced corrugated cardboard sheet having a thickness of 6 mm at a length of 72 mm and a width of 190 mm was used.

(5) As the metal-containing article 50 placed in the carton 500, a bag formed by heat sealing a stacked film having a configuration given below was charged with tablets packed with PTP and closed.

(Configuration of Bag Stacked Film)

Biaxially stretched polyethylene terephthalate film (thickness: 12 μm)/adhesive/biaxially stretched polypropylene film (thickness: 25 μm)/adhesive/aluminum foil (thickness: 7 μm)/adhesive/linear low-density polyethylene film (thickness 80 μm) (sealant layer)

The films were stacked and bonded by a dry lamination method. As the adhesive provided between the films, a dry lamination two-component curable polyurethane adhesive was used.

In the article 50, aluminum foil was contained in the bag and the PTP package.

The article 50 and the spacing member 5 were inserted into the carton 500 so that the article 50 and the spacing member 5 were arranged as shown in FIG. 6. After closing the flap of the opening, the opening was sealed using a hot-melt adhesive to obtain an RFID tag carton of Production Example 4.

### PRODUCTION EXAMPLE 5

An RFID tag carton of Production Example 5 corresponds to the RFID tag carton 600 according to the sixth embodiment. The RFID tag carton of Production Example 5 was produced in the same manner as in Production Example 4 except that the length and the width of the spacing member 5 were respectively changed to 65 mm and 65 mm, and, when packing the carton 600 at the adhesive section 8, the spacing member 5 was bonded to the inner surface of the wall using a vinyl acetate emulsion adhesive at a position at which the RFID tag 20a was provided.

### PRODUCTION EXAMPLE 6

An RFID tag carton of Production Example 6 corresponds to the RFID tag carton 700 according to the seventh embodiment. The RFID tag carton of Production Example 6 was produced in the same manner as in Production Example 4 except for forming the partition plate 6 having the adhesive portions 7a and 7b on either end as the partition plate 6 dividing the inner space of the carton 700 as shown in FIG. 9 by forming a laminate material in which only the outer paper layer 11 and the inner paper layer 12 were bonded using the adhesive layer 14 as the carton laminate material 10 and die cutting the resulting laminate material, and bonding the adhesive portions 7a and 7b to the top plate and the bottom plate of the carton 700 when packing the carton 700 so that the wall in which the RFID tag 20a was provided and the article 50 were separated at a distance of about 12 mm.

### COMPARATIVE EXAMPLE 2

An RFID tag carton of Comparative Example 2 was produced in the same manner as the RFID tag carton of Production Example 4 except that the spacing member 5 was not inserted into the RFID tag carton.

In order to evaluate the RFID tag cartons of Production Examples 4 to 6 and Comparative Example 2 thus obtained, a test was conducted in which each RFID tag carton was used as a sample and information stored in the RFID tag 20a was read using a reader/writer (electromagnetic induction type) at a distance of 30 cm.

As a result, the information could be read from the samples of Production Example 4, 5, and 6, since the RFID tag 20a provided between the paper layers of the carton and the article 50 provided on the back surface were separated by the spacing member 5 or the partition plate 6 at a distance of at least 6 mm.

In the sample of Comparative Example 2, since the spacing member 5 was not inserted between the RFID tag 20a and the article 50, the distance between the RFID tag 20a and the article 50 was reduced to about 1 mm, whereby the information stored in the RFID tag 20 could not be correctly read due to an adverse effect of the aluminum foil contained in the article 50.

### PRODUCTION EXAMPLE 7

In an RFID tag package of Production Example 7 (not shown), the casing was a bag which did not contain paper (hereinafter called “outer bag”), in which a plurality of inner bags were integrally packaged.

(Inner Bag)

The inner bag was formed by forming a laminated film having a configuration given below into a continuous bag in which six small bags sealed on the four sides were separated by perforations in the vertical direction (three bags) and the horizontal direction (two bags). Each small bag was charged with granular articles and then closed. The inner bag had a width of 84 mm and a length of 180 mm.

(Inner Bag Stacked Film)

The inner bag stacked film was a laminate of “biaxially stretched polyethylene terephthalate film (thickness: 12 μm)/adhesive/aluminum foil (thickness: 7 μm)/adhesive/unstretched linear low-density polyethylene film (thickness 40 μm)”.

(Outer Bag)

The outer bag was formed by forming a laminated film having a configuration given below into a gusset type bag so that the width was 84 mm, the length was 180 mm, and the width of the gusset folding portion on each side was 20 mm (the thickness was 40 mm when the bag was spread open).

When forming the outer bag, an RFID tag was bonded to the inner side (side of the sealant layer) of the stacked film at the front side using a hot-melt adhesive.

Eight continuous bag type inner bags charged with the granular articles could be inserted into the outer bag.

(Outer Bag Stacked Film)

The outer bag stacked film was a laminate of “biaxially stretched polyethylene terephthalate film (thickness: 12 μm)/adhesive/biaxially stretched nylon film (thickness: 15 μm)/adhesive/unstretched linear low-density polyethylene film (thickness 100 μm)”.

The RFID tag package of Production Example 7 was formed as follows. Specifically, eight continuous bag type inner bags charged with the granular articles were stacked inside the gusset type outer bag prepared as described above. A foamed polypropylene plate having a width and a length approximately the same as those of the inner bag and having a thickness of 5 mm was stacked on the inner bags as the spacing member. The foamed polypropylene plate was inserted so that the plate was positioned on the side of the RFID tag bonded to the outer bag. The opening of the outer bag was then heat-sealed.

### PRODUCTION EXAMPLE 8

Production Example 8 differs from Production Example 7 in that the RFID tag was inserted between the layers of the outer bag stacked film instead of bonding the RFID tag to the inner side (side of the sealant layer) of the stacked film at the front side using a hot-melt adhesive.

(Outer Bag Stacked Film)

The outer bag stacked film was a laminate of “biaxially stretched polyethylene terephthalate film (thickness: 12 μm) (back side print)/anchor coating/RFID tag/extruded low-density polyethylene (thickness 50 μm)”.

In the outer bag stacked film, a print layer was printed on the back surface of the biaxially stretched polyethylene terephthalate film together with positioning marks. The anchor coating was provided on the printed surface. The RFID tag was bonded to the surface of the anchor coating using an adhesive at intervals at which the outer bag was cut into a gusset bag (so that one RFID tag was assigned to one gusset type bag) according to the positioning marks.

In the outer bag stacked film, the surface of the anchor coating was not completely covered with the RFID tag and was exposed at a percentage of 20% or more. The reason therefor is as follows. Specifically, since the adhesive strength cannot be obtained when extruding the low-density polyethylene onto the RFID tag, the adhesive strength is maintained by increasing the contact area with the surface of the anchor coating exhibiting adhesive strength. The anchor coating was extrusion coated (melt extrusion coated) with the low-density polyethylene (sealant layer) to a thickness of 50 μm.

The RFID tag package of Production Example 8 was formed as follows. Specifically, eight continuous bag type inner bags charged with the granular articles were stacked inside the gusset type outer bag prepared in the same manner as in Production Example 7. A foamed polypropylene plate having a width and a length approximately the same as those of the inner bag and having a thickness of 5 mm was stacked on the inner bags as the spacing member. The foamed polypropylene plate was inserted so that the plate was positioned on the side of the RFID tag provided in the outer bag. The opening of the outer bag was then heat-sealed.

### COMPARATIVE EXAMPLE 3

An RFID tag package of Comparative Example 3 was produced in the same manner as the RFID tag package of Production Example 7 except that the spacing member was not provided.

### COMPARATIVE EXAMPLE 4

An RFID tag package of Comparative Example 4 was produced in the same manner as the RFID tag package of Production Example 8 except that the spacing member was not inserted.

In order to evaluate the RFID tag packages of Production Examples 7 and 8 and Comparative Examples 3 and 4 thus obtained, a test was conducted in which each RFID tag package was used as a sample and information stored in the RFID tag was read using a reader/writer (electromagnetic induction type) at a distance of 30 cm.

As a result, the information could be read from the samples of Production Examples 7 and 8, since the RFID tag provided to the outer bag and the article provided on the back side of the RFID tag were separated by the spacing member at a distance of at least 5 mm.

In the samples of Comparative Examples 3 and 4, since the spacing member was not inserted between the RFID tag and the article, the distance between the RFID tag and the article provided on the back side of the RFID tag was reduced to about 1 mm, whereby the information stored in the RFID tag could not be correctly read due to an adverse effect of the aluminum foil contained in the article.

The present invention is not limited to the above-described embodiments, and various modifications and variations may be made. Such modifications and variations are also within the scope of equivalence of the present invention.

(1) In the present invention, the package may have a configuration in which one inner bag (article) is placed in one casing, or may have a configuration in which two or more inner bags are placed in one casing.

(2) The surface of the casing to which the RFID tag is attached is preferably the outer surface of the casing in order to increase the distance between the RFID tag and the inner bag placed in the casing. Note that the RFID tag may be attached to the inner surface of the casing.

(3) The spacing means is not particularly limited insofar as the spacing means can maintain the inner bag and the RFID tag at a specific distance. In the case where an article which does not contain a metal or the like can be placed in the casing together with the inner bag, the article or the like may be placed between the inner bag and the inner surface of the casing in the area in which the RFID tag is attached so that the RFID tag and the inner bag can be positioned at a specific distance.

(4) It is preferable to use the same material for the casing (e.g. paper board or corrugated cardboard) and the partition plate 6 due to excellent processability, well-balanced strength, and availability. Note that a material differing from the material for the casing may also be used insofar as the material has necessary strength such as rigidity.

(5) The RFID tag package may be suitably used when gas barrier properties and shading properties are required in which the article is packed with a packaging material including metal foil or a metal deposited layer. Note that the article and the application are not limited thereto.

(6) In the first embodiment, the plate-shaped spacing member having a specific thickness is inserted as the spacing means between the face plate of the casing to which the RFID tag is attached and the inner bag. Note that the inner surface of the casing and the inner bag may be bonded in the area in which the RFID tag is positioned at a distance from the inner bag without inserting the spacing member. It suffices that the inner surface of the casing and the inner bag be partially bonded so that movement does not occur during transportation. It is preferable that the inner bag be separated from the inner surface of the casing when removing the inner bag from the casing. The inner surface of the casing and the inner bag may be bonded using a known adhesive such as a hot-melt adhesive.

### INDUSTRIAL APPLICABILITY

According to the RFID tag package of the present invention, even if the inner bag (article) in which an article is airtightly packed is formed by a stacked film (gas barrier layer or shading layer) including metal foil or a metal deposited layer containing aluminum, copper, or the like in order to increase the storage properties of the article, information stored in the IC chip can be externally read or rewritten using electromagnetic waves by attaching the RFID tag to an arbitrary surface of the casing, whereby the efficiency of package (commodity) distribution can be improved.

1. A radio frequency identification (RFID) tag package in which a metal-containing article or an article packed with a metal-containing packaging material is packaged, the RFID tag package comprising: a casing in which the article is packaged; an RFID tag attached to an arbitrary surface of the casing; and spacing means for maintaining the article and the RFID tag at a distance equal to or greater than a specific distance, the spacing means being provided inside the casing at least in the area in which the RFID tag is attached.

2. The RFID tag package according to claim 1, wherein the article is airtightly packed with a packaging material formed by a stacked film including metal foil or a metal deposited layer.

3. The RFID tag package according to claim 1, wherein the spacing means is a sheet having a specific thickness, the sheet being inserted between the article and the area of the casing in which the RFID tag is attached and having an air layer and/or a bubble layer.

4. The RFID tag package according to claim 1, wherein the spacing means is a sheet having a specific thickness, the sheet being bonded to an inner surface of the casing in the area in which the RFID tag is attached and having an air layer and/or a bubble layer.

5. The RFID tag package according to claim 1, wherein the spacing means is a partition plate which divides an inner space of the casing into a first portion including an area in which the RFID tag is attached and a second portion in which the RFID tag is not attached, and the article is packaged in the second portion.

6. The RFID tag package according to claim 1, wherein a recess portion is formed in an outer surface of the casing, and the RFID tag is provided in the recess portion.

7. The RFID tag package according to claim 1, wherein the casing is formed by a laminate material obtained by attaching a plurality of sheets including at least one paper sheet, and the RFID tag is provided between the sheets of the laminate material.

8. The RFID tag package according to claim 7, wherein the laminate material includes at least one paper sheet, a recess portion is formed in the paper sheet, and the RFID tag is provided in the recess portion.

9. The RFID tag package according to claim 7, wherein a camouflaging print layer, which prevents surface deformation due to the RFID tag from being observed, is provided on the outer surface of the casing in the area in which the RFID tag is attached.

10. The RFID tag package according to claim 1, wherein the casing is formed by a stacked film which does not include paper.

11. The RFID tag package according to claim 1, wherein the casing is formed by a laminate material prepared by attaching two or more sheets, and the RFID tag is provided between the sheets of the laminate material.

12. The RFID tag package according to claim 1, wherein the inner side of the casing and the article are bonded in an area at a distance equal to or greater than a specific distance from the RFID tag.
